(19) United States
(12) Patent Application Publication
(10) Pub. No.: US 2021/0080983 A1
(43) Pub. Date: Mar. 18, 2021

(54) BINOCULAR VISION OCCUPANCY DETECTOR

(71) Applicant: The Trustees of Princeton University, Princeton, NJ (US)

(72) Inventors: Forrest MEGGERS, Princeton, NJ (US); Jake READ, Toronto (CA); Eric TEITELBAUM, Princeton, NJ (US); Nicholas B. HOUCHOIS, Princeton, NJ (US)

(73) Assignee: The Trustees of Princeton University, Princeton, NJ (US)

(21) Appl. No.: 16/611,878

(22) PCT Filed: May 11, 2018
(86) PCT No.: PCT/US2018/032298

§ 371 Date: Nov. 8, 2019

Related U.S. Application Data
(60) Provisional application No. 62/504,916, filed on May 11, 2017.

(51) Int. Cl. G05D 23/19; G01J 1/02; G01J 5/08; G01C 3/08

(52) U.S. Cl. CPC G05D 23/1932; G01J 1/0266; G01J 5/0809; G01J 2005/0077; G01C 3/085; G01J 5/089; G01J 5/0834

(57) ABSTRACT

Occupancy detection is an increasingly important part of building control logic, as new systems and control logic greatly benefit from human-in-the-loop sensing. Current approaches such as CO₂ monitoring, acoustic detection, and PIR based motion detection are limited in scope, as these variables are a proxy for occupancy, and at best can be roughly correlated to occupancy, and cannot reliably provide a count of the number of occupants. The disclosed sensor uses thermal information that is continually being emitted by human occupants and optical processing to count and spatially resolve the location of occupants in a room, allowing ventilation flow rates to be properly controlled and directed, if enabled. Occupant detection and counting cheaply and reliably without moving parts is the holy grail of building controls at the moment, which are the basic design principles behind the disclosed inexpensive, static, and stable thermographic occupancy detection sensor.

### CROSS-REFERENCE TO RELATED APPLICATIONS

This application claims priority to U.S. Provisional Application No. 62/504,916, filed May 11, 2017, which is herein incorporated by reference in its entirety.

### TECHNICAL FIELD

This relates generally to thermal imaging, and more particularly, to binocular vision thermal sensor systems.

### BACKGROUND

Many companies are focusing on driving down the costs of operating or using industrial, commercial, and/or residential buildings. To date, the focus has been on controlling lighting, as much of the costs due to lighting are wasted, either because the area is unoccupied or is otherwise sufficiently illuminated or temperature controlled during daylight hours by sunlight passing through windows. Some static methods have been used to improve the situation. These include removing lamps from certain fixtures and using lamps which are more efficient than conventional incandescent and fluorescent lights. In more recent years, automatic control systems have been tried. A simple form of automated control employs computers or timers to turn the lights on and off at preset times. This occurs so that after working hours the lights are not accidentally left on. The problem with such a system is that frequently it is necessary to have the lights on at night fir maintenance and cleaning personnel, as well as regular employees who must work late. A more sophisticated control system may use photodiodes to control the lighting system based on available ambient lighting. Such a system can turn off unneeded lights or dim their output when sufficient sunlight is available. With photodetector type lighting control systems, there is still wasted energy because lights are not turned off in unoccupied areas.

However, while lighting systems do consume significant amounts of energy, HVAC systems often consume far more energy—six times or more—than lighting systems. Unfortunately, current sensors are not reliable or accurate enough to control HVAC systems, or other systems with long time lags and potentially dangerous conditions (e.g., if ventilation rates are too low).

When designing systems that control conditions within a building, architects and engineers build controls around the comfort experienced by a person, which is a result of the cumulative effect of environmental conditions, including the Mean Radiant Temperature (“MRT”) of a location, air temp, humidity, etc. Even though MRT drives more than 50% of the thermal comfort a user experiences in typical indoor conditions, designers currently ignore this in favor of proxies for MRT, due to the lack of good sensors. The most accurate system to date for measuring MRT requires a very costly and time-consuming process involving multiple radiometers taking a wide range of readings. As has been a standard practice for decades, however, those in building sciences typically measure MRT using a black-globe thermometer. A black-globe thermometer consists of a black globe with a temperature sensor probe placed in the center. However, the black-globe thermometer does not actually measure surrounding temperatures, but rather the internal thermometer or sensor simply outputs the mean temperature of the black globe surrounding it. Thus, a black-globe thermometer cannot easily provide information about the MRT of multiple parts of a location, but only the area immediately adjacent to the globe. Therefore, to capture information about a space at a given point in time, multiple black globe thermometers would be necessary. The globe can in theory have any diameter, but standardized globes are made with diameters of 0.15 m (5.9 in). Large globes are bulky and not aesthetically pleasing, but the smaller the diameter of the globe, the greater the effect is of air temperature and air velocity on the internal temperature, thus causing a reduction in the accuracy of the measurement of the MRT. Efforts to avoid those drawbacks, by using non-contract infrared sensors (see, e.g., PCT/US2016/023735), have required the use of moving or rotating parts, which increases cost and decreases reliability.

One way of correcting this is by incorporating accurate occupancy detectors into the control system. Occupancy detection is an increasingly important part of building control logic, as new systems and control logic greatly benefit from human-in-the-loop sensing. Occupant detection and counting cheaply and reliably without moving parts is the holy grail of building controls at the moment. Current approaches such as CO2 monitoring, acoustic detection, and PIR based motion detection are limited in scope, however, as these variables are a proxy for occupancy, and at best can be roughly correlated to occupancy, and cannot reliably provide a count of the number of occupants.

Thus, an inexpensive, reliable system for accurately detecting number of occupants in a given location is desirable.

### SUMMARY OF INVENTION

The present disclosure is drawn to an infrared sensor that utilizes an infrared detector and infrared reflective surfaces, preferably two convex surfaces, to reflect the infrared radiation towards the infrared detector in order to allow the sensor to utilize at least binocular vision to view of a volume of space around the sensor. Advantageously, the infrared detector may be an infrared pixel array, and may further be an array of 480 or more pixels. It may be beneficial for the two convex surfaces to be two discrete mirrors, or two different areas of a single mirror. It may also be advantageous to use a beamsplitter, filter, and/or shutter. It is also advantageous for the infrared sensor to utilize a housing, which may be adapted for mounting on a wall, or other components, including a transceiver and a processor. The processor is advantageously configured to determine thermal contours based on pixel data, and estimate at least one of an object's size, location or temperature, preferably using a machine learning algorithm,

A method is disclosed that is drawn to detecting room occupancy. The method requires capturing pixel data from an infrared pixel array having two or more distinct groups of pixels, and if the temperatures represented by the pixel data are within a particularly desired range, such as would indicate a human being, determining contours from the two different groups of pixels. The contours are then checked for congruency, and if they are sufficiently congruent, the method requires estimating an object's size, location, and/or temperature for the contours, and outputting that estimation. Advantageously, those estimations are output via a transceiver wherein the outputting of at least one estimation comprises transmitting the estimation using a transceiver. Of further advantage is also transmitting at least some information related to the captured pixel data to a database for use by a machine learning algorithm.

### BRIEF DESCRIPTION OF DRAWINGS

FIGS. 1 and 2 are depictions of one embodiment of a binocular vision occupancy detector.

FIG. 3 is a flowchart describing a calibration mode.

FIG. 4 is a flowchart describing a normal operation mode.

### DETAILED DESCRIPTION

Unless defined otherwise above, all technical and scientific terms used herein have the same meaning as commonly understood by one of ordinary skill in the art to which this invention belongs. Where a term is provided in the singular, the inventor also contemplates the plural of that term.

The singular forms “a”, “an”, and “the” include plural references unless the context clearly dictates otherwise.

The terms “comprise” and “comprising” is used in the inclusive, open sense, meaning that additional elements may be included.

The terms “infrared” or “IR” are generally understood as electromagnetic radiation having wavelengths from the red edge of the visible spectrum (around 700 nm) to wavelengths of about 1 mm. For example, the International Commission on Illumination (CIE) recommended the division of infrared radiation into three distinct bands: IR-A (wavelengths of 700 nm-1400 nm); IR-B (wavelengths of 1400 nm-3000 nm); and IR-C (wavelengths of 3000 nm-1 mm).

Disclosed is an inexpensive device and a method for using thermal information that is continually being emitted by human occupants and optical processing to count and spatially resolve the location of occupants in a room, allowing ventilation flow rates or illumination to be properly controlled and directed, if enabled.

The disclosed system generally utilizes an infrared (IR) detector coupled with a means for enabling at least binocular vision in conjunction with the IR detector. The means for enabling at least binocular vision can include, but is not limited to, the use of two discrete mirrored surfaces to reflect IR towards the IR detector, or a single mirrored surface with at least two regions, where each region is capable of reflecting IR towards the IR detector.

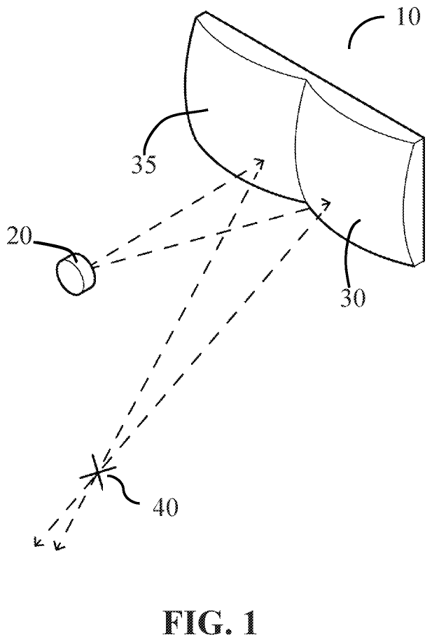

Referring to FIG. 1, a simplified embodiment of one system is illustrated. As shown, a sensor (10) requires an IR detector (20), which may include but is not limited to an IR pixel array. The device (10) in FIG. 1 also includes one or more IR reflective surfaces (30, 35), such as convex optic elements.

In preferred embodiments, the reflectivity of the IR reflective surfaces (30, 35) should be above 80% for at least one wavelength capable of being detected by the IR detector (20). Metals such as aluminum, silver, or gold are typically utilized, although other approaches (e.g., IR reflective tape, IR reflective paint or pigmentation of a surface, etc.) that provides the necessary reflectivity may also be used.

The IR detector is positioned so as to receive infrared radiation emitted from at least one point-location of a measured object (40) after the infrared radiation is reflected off one or more optic element (30, 35) towards a detector (20). In preferred embodiments, one half of a detector array (20) is observing one mirror or surface (30) and the other half is observing the other mirror or surface (35), allowing for binocular vision and, e.g., a 3D reconstruction of the location of a person in space. However, other configurations, especially if more than 2 mirrors are utilized, are envisioned, such as a system using four mirrors, where each mirror is observed by a quarter of the detector pixels. In addition, the field of view can be altered by adjusting the shape(s) of the convex optic elements, including the use of complex reflector shapes. In some embodiments, the one or more optic element (30, 35) comprises at least two convex optic elements, and generally positioned so substantially any location within a desired field of view will be reflected towards the. However, other embodiments are envisioned that do not necessarily have two mirrors splitting the field of view (FOV) of the detector. Other embodiments may also include, for example, a single mirror that is approached from different angles, or using two mirrors that both reflect onto the entire sensor and, e.g., using shutters to alternate which mirror the detector is detecting radiation from, or using some signal processing to determine the deltas between the two mirrors. Further, the mirrors could also be slightly offset from each other and individual pixels could be compared.

In systems using an infrared pixel array as the IR detector (20), the array preferably contains 80×60 pixels or greater. The size of the pixel array is often tradeoff between accuracy and processing requirements. For example, an 8×2 array has very low power requirements and cost, and can make determinations quickly, but such a system may not be able to provide sufficiently accurate counts of individuals in a room in certain applications. Conversely, a 400×400 pixel array can provide a high degree of accuracy, but such a system will likely be more expensive and have significantly higher processing requirements than the 8×2 array but may not be as responsive as desired in some applications.

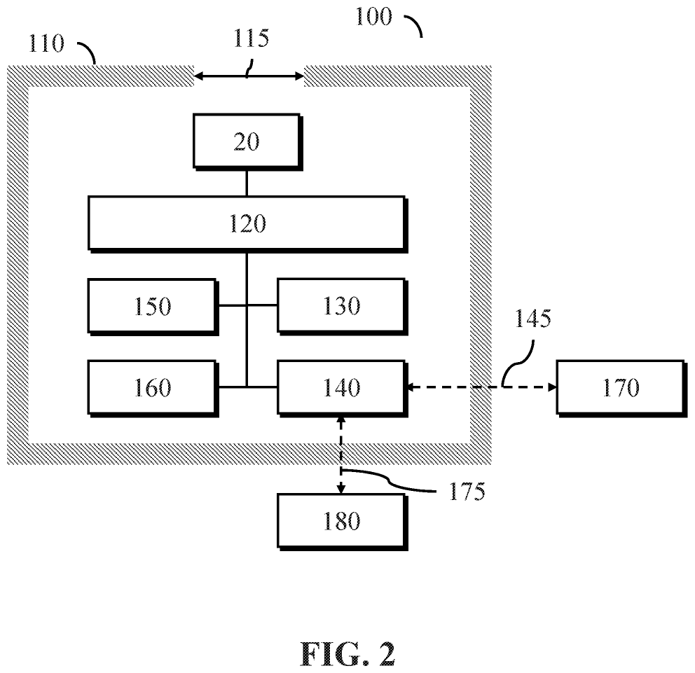

Referring now to FIG. 2, the disclosed system (100) may also include other elements. The IR detector (20) and convex optic elements (not shown) are typically arranged within a housing (110). The housing (110) will typically be configured to define either an opening (115) or have an IR-transparent portion (not shown) for allowing IR radiation to reach the detector (20). Typically, the sensor may also include, but are not limited to, a processor (120), memory (130), a wired or wireless transceiver (140), a display (150), and an ambient temperature sensor (160). Still other components may be included—amplifiers, preamplifiers, ADCs and DACs, etc. as would be known to those of skill in the art. If a processor (120) is included, the processor (120) can handle data in a variety of ways, including but not limited to preparing data from the IR detector (20) for transmitting to a central computer or cloud-based service (170) via a wired or wireless connection (145), or the processor (120) may provide all the necessary data processing. In various embodiments, the sensor may connect to the central computer or cloud-based service (170) continuously, periodically or irregularly.

The system may also be in wired or wireless communication (175) with other devices (180), which may include one or more lights, one or more HVAC systems, one or more other binocular vision occupancy detectors, and/or one or more other electrical devices.

For example, a room may have a sensor mounted in a room, along with an acoustic detector. The acoustic detector may share information with the sensor in order to improve detection accuracy.

In another example, a room may have a sensor mounted on the ceiling, facing down towards the floor, or on one wall facing outwards towards a room, and if the sensor detects that people have entered, it may automatically turn on lights on just one side of a room, provide power to a built-in television, and tell an HVAC system where the people are sitting in order to send conditioned air to that general location and keep them comfortable. Similarly, when the occupants leave, the sensor may automatically turn off the lights, turn off power to particular electrical outlets, and return the HVAC to a preprogrammed unoccupied setting.

In a third example, if two or more occupancy detectors are in a room, they may be configured to share data, allowing the processors to make calculations and decisions based on a larger, more complete data set. In those instances, there may also be some algorithm used for resolving conflicts. For example, if a single surface is measured by two different sensors, and the measured temperatures are not identical, the data may be averaged, or may be filtered out if the difference between the temperatures is larger than a predetermined threshold.

In instances where a temperature reading is not consistent with other data known to the system, a notification may be provided to a user (e.g., email, text message, visual display, etc.) that one or more sensors, preferably providing an identification of the sensors and/or a location, may need calibration or replacement.

Operation of the system may include one or more modes. In some embodiments, two modes are envisioned—a calibration mode and an operating mode. Typically, calibration is optional, and the need for calibration may also be detector or sensor dependent. For example, some detectors or sensors may not require calibration in order to meet the desired degree of accuracy.

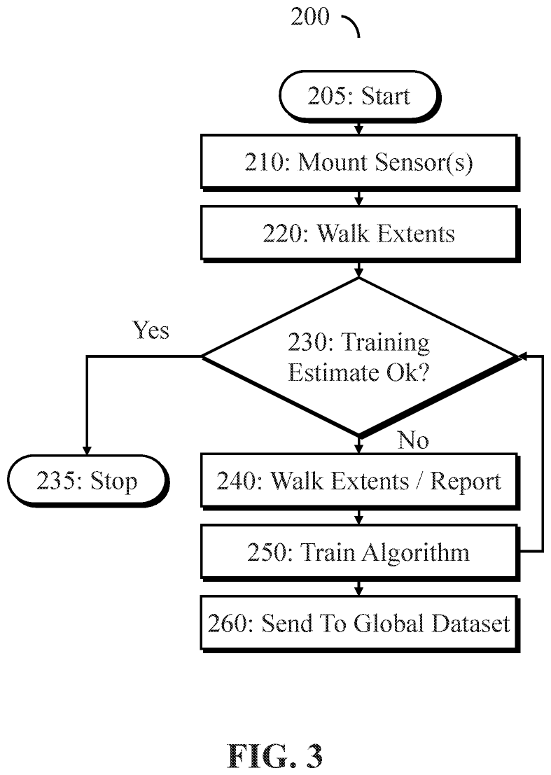

While calibration may involve nothing more than providing a building information model and/or floorplan to the sensor system, other calibration steps or techniques may be required. Referring now to FIG. 3, a flowchart describing one possible technique (200) for implementing a calibration mode is shown. To improve accuracy, the calibration mode typically begins (205) by first installing (210) one or more sensors in a room, although the sensors may also be calibrated at other points in time. As shown in FIG. 2, following the mounting of a sensor (210) in a fixed location, a user walks the extent of space that the sensor will detect (220), and the dataset is stored in, e.g., memory (130). The sensor then uses a training algorithm to estimate the user position relative to the sensor (230). If that estimate is acceptable, the calibration is complete (235). If not, the user may again walk the space, and manually report the location relative to the sensor (240), after which the sensor's algorithm is trained with the new data (250). At a minimum, the new algorithm is used to again estimate the user position relative to the sensor based on the captured dataset (230). If the estimate is still not acceptable, this training process is repeated. In preferred embodiments, the new data for training algorithms and/or the new trained algorithms are also sent to a global dataset (260). The global dataset may be located in a database at almost any location, including a centrally-located server or a cloud-based service. Some or all of the above calibration steps may be done by the device manufacturer, e.g., as part of the initial machine learning models, rather than by a user during sensor installation.

Once the sensor has been calibrated, the device may begin normal operations. In this operating mode, the sensor preferably runs continuously. Preferably, the sensor runs between 1 and 100 Hz, and more preferably between 5 and 20 Hz, and still more preferably at approximately 10 Hz. In some embodiments, this rate may vary based on a variety of factors, including but not limited to occupancy. For example, if the room is determined to be occupied, the sensor may run at 10 Hz, but when the room is determined to be no longer occupied, the sensor may only run at 0.5 Hz. Alternatively, the sensor may receive input from another sensor or device in order to determine how fast to cycle. For example, during normal business hours, the device might operate at 20 Hz, but after normal business hours, it might only operate at 0.1 Hz. Or when an ID card scanner first indicates someone is about to enter the building, the system may take readings 10 times a second, but when the card system indicates no one is supposed to be in the building, the system might only take a reading every minute.

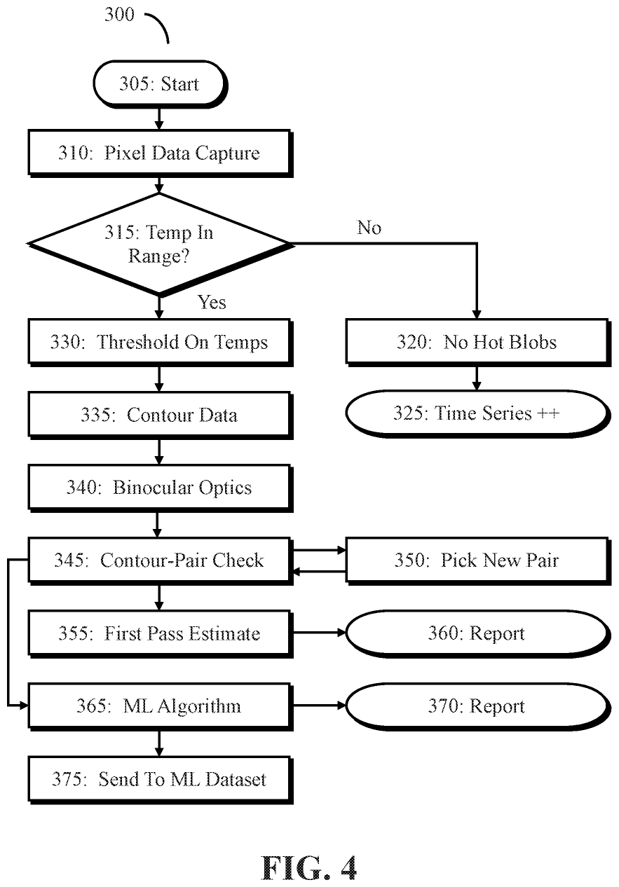

Referring now to FIG. 4, a flowchart describing one embodiment of an operating mode is depicted. In the normal operating mode (300) the process starts (305) with pixel data being captured (310), and a determination (315) is made whether any measured temperature values for an initial time series are within a given range. For occupancy detection, the range will typically be normal ranges of human body temperature, with corrections for, e.g., the reflectivity of the convex optic elements.

If no hot blobs are indicated or flagged as being detected (320), the time series is incremented (325). If the system detects a temperature within a given range, the system uses threshold temperatures (330) and builds contour data (335) for each mirror. Since each pixel in, e.g., a given detector array is typically dedicated to a specific mirror, the sensor can then use a binocular optics function (340) to check pairs of contours for congruency (345, 350) until a pair passes the congruency check. Once the congruency check passes, the system could estimate (355) an object's size and temperature, and report that (360). In some simple systems, a single pair of congruent contours may be all that is required, however, other systems may also continue checking for other contour pairs. The system may also use the calibration data to estimate the object's location within the room (365) and report that (370). In addition, typically at least some of the data is then passed to the global dataset for future learning (375).

It should be noted that one skilled in the art will recognize that various machine learning techniques may be utilized with these sensors. For example, the machine learning technique that is utilized can include, but is not limited to, decision trees, kernel ridge regression, support vector machine algorithms, random forest, naive Bayesian, k-nearest neighbors (K-NN), and least absolute shrinkage and selection operator (LASSO). Unsupervised machine learning algorithms and Deep Learning algorithms can also be used, which can include, but is not limited to, Temporal Convolution Neural Networks. Further, multiple statistical models can be combined.

Another example of the SMART sensor system begins by identifying all possible areas representing a person before using a series of checks using its hybrid thermal-geometric data to move towards the ground truth and reduce the variance. The first analysis uses temperature data to identify all points within an appropriate temperature band. The mean may be very high due to a large number of false positives and the variance may also be high. Analyzing the shape of the object(s) may eliminate some of the false positives. This reduces both the mean and the variance. The distance data may be used to calculate the size of the object; further reducing the mean and variance. This brings the prediction closer to the ground truth, however, it causes a risk of false negatives which could compromise occupant comfort. Consequently, the system can use information about the 3D geometry of the room (such as that information either collected using the LiDAR or from CAD/BIM models) to calculate occlusion and find any false negatives that may have been incurred in the previous steps. This prevents false negatives that could undermine occupant comfort and slightly increases both the mean and variance. Further, the system may account for these increases by introducing multiple scans done over time within each 30 minute period. In this example, during each period, the system may complete at least thirty (30) three hundred and sixty degree scans.

The disclosed sensor may be configured to allow a user to acquire Thermal-D data (as opposed to RGB-D), which in turn allows, e.g., the ability to detect the geometry and thermal characteristics of a space in addition to detecting and counting people. Thus, these sensors may be used for a variety of applications. In some embodiments, the sensor is used for the detection, characterization and tracking of unsafe environmental conditions. For example, fires, frozen pipes, risk of cold exposure. This can include environmental conditions that are unsafe for non-human purposes (e.g. too cold for a type of plant or animal, too hot for food storage etc.). Other embodiments include for detection, characterization and tracking of gases/liquids. For example, gas leaks or liquid spills. Different gases/liquids affect reflectivity, emissivity and transmissivity in ways that may be detected (either manually or automatically) using the sensor. Similarly, the sensors can be used to detect changes in surfaces—such as liquids on surfaces. So, if a pipe bursts, and water starts covering a floor, the sensor can detect the difference (compared to a previously measured surface) and can notify or alert individuals as needed.

Other embodiments can be used for the analysis of buildings. Such analyses include, but are not limited to, the thermal and energy performance of spaces. For example, finding areas with a lack of insulation. In one embodiment, the sensor measures surfaces of a room, and compares to surrounding locations, and if, e.g., one area of a wall does not have similar characteristics to another area of the same wall, an insulation or other performance issue is noted. The sensor may be permanently or temporarily installed for these analyses. Further, the sensor can take these analyses into account, and adjust the setpoint of, e.g., a conventional thermostat to make occupants more comfortable and reduce energy consumption. In some embodiments, the sensor is configured to be used to calibrate energy models for heat loss and insulation levels in building simulation and analysis, or to commission building systems, particularly new radiant systems, to ensure appropriate comfort via measurement of predicted/expected/needed MRT. In some embodiments, the sensor can also be used to quantify and confirming energy savings and operational performance of buildings.

Other embodiments include a system configured to determine control metrics for a building and/or volume of space. For example, calculating metrics that involve radiative heat transfer (such as operative temperature) and using this information to determine and verify setpoints for HVAC systems. In some embodiments, the determination involves a combination of input from occupants and data from the sensor to control environmental conditions. In some embodiments, the solicitation of input from occupants is based on data from the sensor.

Other embodiments include using the sensor system to generate 3D and 2D models and/or representations of spaces and buildings using data from the sensor. For example, a floorplan with thermal information or a 3D model of a building. The sensor can also be used to generate 2D images of surfaces, scenes and environments, or to generate 3D point clouds of surfaces, scenes and environments. Alternatively, or in addition to the above, the system can be used for the meshing of point clouds to model and find surfaces and objects.

Further, while the sensor system can be used to control actuators using MRT data, the system can also control and/or inform HVAC systems with data other than mean radiant temperature (MRT). For example, number of occupants, human thermal load or custom metrics such as Average MRT throughout a space. In addition, other components can be incorporated into the sensor system, including but not limited to a visual camera, an air quality sensor (including but not limited to temperature and humidity sensors), a gas detector, another radiation sensor (including but not limited to UV and visual light), a structured light sensor, and a time of flight camera. These additional components can provide additional data that can be used to inform calculations and or control determinations. Alternatively, the sensor can be configured to control building systems other than HVAC, including but not limited to lighting, security locks, garage doors, etc.

In some embodiments, these sensor systems can be used in non-building applications as well. For example, they can be used in vehicles, or for medical diagnostic purposes.

In some embodiments, these sensors enable the determination of the effects of the radiative environment on a real or hypothetical person, animal or object.

Further, the sensors are potentially configurable to allow for oversampling of points and use of any distribution of points, or to use variable scan patterns. For example, the scan pattern can be configured such that distance information is used to oversample far away surfaces and generate a constant scan density across surfaces, or oversample areas of interest such as potential people when doing occupancy detection.

In some embodiments, the data gathered from the sensor is used to calculate occlusions.

In some embodiments, the system is configured to make a determination of thermal comfort, based on the data it receives from the sensor, or from the sensor and other components providing additional data. In some embodiments, the system is configured to make adjustments or weighting of readings or factors to account for clothing, emissivity of surfaces or transmissivity of objects.

In some embodiments, the sensor is configured to, e.g., track a person or object. This may be informed by other sensors that are either separate or incorporated into or with the sensor. For example, a visual camera may be used to find areas of interest that the sensor can focus on or scan.

In some embodiments, building information models (BIM) is integrated with the data from the sensor.

Various modifications and variations of the invention in addition to those shown and described herein will be apparent to those skilled in the art without departing from the scope and spirit of the invention and fall within the scope of the claims. Although the invention has been described in connection with specific preferred embodiments, it should be understood that the invention as claimed should not be unduly limited to such specific embodiments.

In addition, the references listed herein are also part of the application and are incorporated by reference in their entirety as if fully set forth herein.

What is claimed:

1. An infrared sensor, comprising:
an infrared detector;
at least two portions of surfaces capable of reflecting infrared radiation, each portion configured to reflect the infrared radiation towards the infrared detector.

2. The infrared sensor according to claim 1, further comprising a housing for the infrared detector and the at least two portions of surfaces.

3. The infrared sensor according to claim 2, wherein the housing is adapted for mounting on a wall.

4. The infrared sensor according to claim 2, further comprising a processor configured to receive input from the infrared detector.

5. The infrared sensor according to claim 4, further comprising a transceiver configured to receive data from the processor.

6. The infrared sensor according to claim 4, wherein the processor is configured to determine thermal contours based on pixel data, and estimate at least one of an object's size, location or temperature.

7. The infrared sensor according to claim 6, wherein the estimation is accomplished based on a machine learning algorithm.

8. The infrared sensor according to claim 1, wherein the at least two portions of surfaces comprise different areas of a single mirror.

9. The infrared sensor according to claim 1, wherein the at least two portions of surfaces comprise two discrete mirrors.

10. The infrared sensor according to claim 1, wherein the infrared detector is an infrared pixel array.

11. The infrared sensor according to claim 1, wherein the infrared pixel array comprises an array of at least 480 pixels.

12. The infrared sensor according to claim 1, wherein the sensor further comprises at least one component selected from the group consisting of a beam splitter, shutter, and lens.

13. The infrared sensor according to claim 1, wherein a first portion a surface of is configured to reflect radiation from a first point in space towards a first portion of the sensor and radiation from a second point in space towards a second portion of the sensor or to the first portion of the sensor at a different point in time.

14. A method for detecting room occupancy, the method comprising the steps of:
capturing at least two sets of pixel data from an infrared pixel array;
determining if temperatures represented by the pixel data are within a first range;
determining at least two contours, each contour from a different set of pixel data;
checking congruency of the at least two contours;
estimating at least one variable selected from the group consisting of an object's size, location and temperature, for congruent contours; and
outputting the at least one estimation.

15. The method according to claim 14, wherein the outputting of at least one estimation comprises transmitting the estimation using a transceiver.

16. The method according to claim 14, further comprising transmitting at least some information related to the captured pixel data to a database for use by a machine learning algorithm.

17. The method according to claim 14, wherein the infrared pixel array is divided into at least two distinct groups of pixels and each contour is from a different group of pixels.

18. The method according to claim 14, wherein estimating comprises using parallax calculations to estimate depth.
